(19) United States
(12) Patent Application Publication
(10) Pub. No.: US 2023/0267312 A1
(43) Pub. Date: Aug. 24, 2023

(54) Training Support Method

(71) Applicant: SHIMADZU CORPORATION, Kyoto-shi (JP)

(72) Inventors: Kenta CHINOMI, Kyoto-shi (JP); Kaori SUGIMURA, Kyoto-shi (JP); Shinji KANAZAWA, Kyoto-shi (JP)

(21) Appl. No.: 18/111,105

(22) Filed: Feb. 17, 2023

(30) Foreign Application Priority Data
Feb. 18, 2022 (JP) 2022-023678
Feb. 13, 2023 (JP) 2023-020131

(51) Int. Cl. G06N 3/0464; G06N 3/09

(52) U.S. Cl. CPC G06N 3/0464; G06N 3/09

(57) ABSTRACT

A training support method includes: acquiring a first chromatogram; displaying a first chromatogram image; acquiring a second chromatogram identical or similar to the first chromatogram and second peak information specifying one or more peaks of the second chromatogram from a chromatogram DB; displaying a second chromatogram image and a second peak information image; receiving input, by a user, of first peak information specifying one or more peaks of the first chromatogram; and training an estimation model based on the first chromatogram and the first peak information.

### BACKGROUND OF THE INVENTION

### Field of the Invention

The present disclosure relates to a training support method.

### Description of the Background Art

WO 2017/040487 discloses a chromatographic system. This chromatograph system detects a peak by artificial intelligence (AI) using an estimation model, and performs qualitative analysis or quantitative analysis of a sample based on the peak.

WO 2017/040487 discloses a technique in which a user can input training data in order to train an estimation model. Specifically, the technique in which the user visually checks an unseparated chromatogram in which peaks are not separated, and inputs information about designation of the peak to a chromatograph system as the training data is disclosed.

### SUMMARY OF THE INVENTION

Sometimes annotation of a large amount of training data is required to prepare the estimation model, and it is desired that variation of the annotation is prevented to improve quality of the estimation model.

The present disclosure has been made to solve such a problem, and an object of the present disclosure is to improve the quality of the estimation model by preventing variations in annotations.

A training support method of the present disclosure is a method for causing a computer to execute processing for assisting a training operation of an estimation model used to detect a peak of a signal waveform acquired by an analysis device. The training support method includes acquiring a first signal waveform output by an analysis device. The training support method includes displaying the first signal waveform on a display device. The training support method includes acquiring a second signal waveform having a high similarity degree with the first signal waveform and second peak information specifying one or more peaks of the second signal waveform from a storage device that stores a plurality of annotated signals. The training support method includes displaying, on the display device, the second signal waveform and a second peak information image indicating second peak information. The training support method includes receiving input, by a user, of first peak information specifying one or more peaks of a first signal waveform. The training support method includes training an estimation model based on the first signal waveform and the first peak information.

A training support program of the present disclosure is a program for causing a computer to execute processing for supporting a training operation of an estimation model used to detect a peak of a signal waveform acquired by an analysis device. The training support program causes the computer to acquire a first signal waveform output by an analysis device. The training support program causes the computer to display the first signal waveform on a display device. The training support program causes the computer to acquire a second signal waveform having a high similarity degree to the first signal waveform and second peak information specifying one or more peaks of the second signal waveform from a storage device that stores a plurality of annotated signals. The training support program causes the computer to display, on the display device, the second signal waveform and a second peak information image indicating the second peak information. The training support program causes the computer to receive input, by a user, of first peak information specifying one or more peaks of the first signal waveform. The training support program causes the computer to train the estimation model based on the first signal waveform and the first peak information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a configuration example of an analysis system.

FIG. 2 is a view illustrating an example in which different training data is assigned to the same chromatogram.

FIG. 3 is a block diagram illustrating a hardware configuration example of a training support device according to a first embodiment.

FIG. 4 is a functional block diagram illustrating the training support device.

FIG. 5 is a view illustrating an example of a chromatogram DB.

FIG. 6 is a view illustrating an example of a screen displayed on a display device.

FIG. 7 is a view illustrating an example of the screen displayed on the display device.

FIG. 8 is a view illustrating an example of the screen displayed on the display device.

FIG. 9 is a flowchart illustrating processing of the training support device.

FIG. 10 is a flowchart illustrating processing of a training support device according to a second embodiment.

FIG. 11 is a flowchart illustrating processing of a training support device according to a third embodiment.

FIG. 12 is a view illustrating an example of a screen displayed on the display device.

### DESCRIPTION OF THE PREFERRED EMBODIMENTS

Hereinafter, embodiments of the present invention will be described in detail with reference to the drawings. In the drawings, the same or corresponding part is denoted by the same reference numeral, and the description thereof will not be repeated.

### First Embodiment

[Analysis System]

The present disclosure relates to a technique for supporting training of an estimation model used to detect a peak of a signal waveform output by an analysis device. Examples of the analysis device include a gas chromatograph (GC) device, a liquid chromatography (LC) device, a mass spectrometer, a spectrophotometer, and an X-ray analyzer.

For example, the signal waveform may be a chromatogram waveform or a mass spectrum waveform. When the analysis device is the spectrophotometer, the signal waveform is an absorption spectrum waveform. When the analysis device is the X-ray analyzer, the signal waveform is an X-ray spectrum waveform.

Furthermore, training (training processing) of an estimation model (estimation model 121 described later) includes processing for newly generating (constructing) an unconstructed estimation model and processing for updating an already constructed estimation model. “Updating the estimation model” includes processing for updating a parameter of the estimation model. Furthermore, the estimation model updated (optimized) by the training processing is also referred to as a “trained model”. The pre-trained estimation model and the trained estimation model are collectively referred to as an “estimation model”.

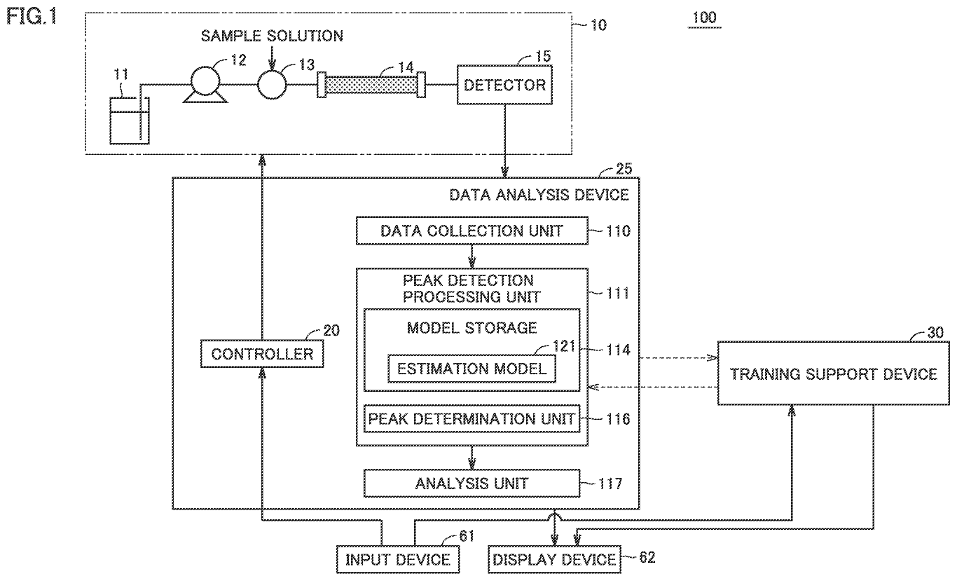

In the first embodiment, the analysis device in which the liquid chromatograph is adopted will be described. FIG. 1 is a view illustrating a configuration example of an analysis system 100. Analysis system 100 includes an analysis device 10, a data analysis device 25, an input device 61, a display device 62, and a training support device 30. For example, data analysis device 25 and training support device 30 is configured of an information processing device (for example, a personal computer (PC)). Data analysis device 25 and training support device 30 are individually illustrated in the example of FIG. 1, but may be integrated.

Input device 61 is a pointing device such as a keyboard or a mouse, and receives an instruction from a user. For example, display device 62 includes a liquid crystal display (LCD) panel. Display device 62 displays various images. When a touch panel is used as a user interface, input device 61 and display device 62 are integrally formed. Input device 61 is connected to data analysis device 25 and training support device 30. Display device 62 is connected to data analysis device 25 and training support device 30.

Data analysis device 25 includes a controller 20. Controller 20 controls analysis device 10. Analysis device 10 includes a mobile phase container 11, a pump 12, an injector 13, a column 14, and a detector 15. Mobile phase container 11 stores a mobile phase. Pump 12 sucks the mobile phase stored in mobile phase container 11 and feeds the mobile phase to column 14 at a substantially constant flow speed (or flow rate).

Injector 13 injects a prescribed amount of sample solution into the mobile phase at prescribed timing according to an instruction from controller 20. The injected sample solution is introduced into column 14 along the flow of the mobile phase. Various compounds contained in the sample solution are separated and eluted in a time direction while passing through column 14. That is, column 14 separates compounds contained in the sample liquid according to a retention time.

Detector 15 detects compounds in an eluent eluted from column 14. Detector outputs a detection signal having intensity corresponding to a compound amount to data analysis device 25. For example, an optical detector or the like adopting a photodiode array (PDA) detector or the like is used as detector 15.

In addition to controller 20, data analysis device 25 includes a data collection unit 110, a peak detection processing unit 111, and an analysis unit 117.

Data collection unit 110 samples the detection signal output from detector 15 at prescribed time intervals, and converts the detection signal into digital data. Data collection unit 110 stores the digital data in a prescribed storage region (not illustrated). The digital data is data (hereinafter, also referred to as “chromatogram data”) indicating the chromatogram waveform.

Peak detection processing unit 111 estimates (derives) the peak of the chromatogram by the chromatogram data collected by data collection unit 110 using artificial intelligence (AI).

In the first embodiment, peak detection processing unit 111 includes a model storage 114 and a peak determination unit 116. For example, model storage 114 stores an estimation model 121 (neural network) generated by machine learning. For example, estimation model 121 is expressed by a prescribed function. For example, the prescribed function is an exponentially modified gaussian (EMG) function.

Peak determination unit 116 inputs the chromatogram based on the chromatogram data collected by data collection unit 110 to estimation model 121. Estimation model 121 outputs the peak of the chromatogram. As described above, peak detection processing unit 111 estimates the peak of the chromatogram by the chromatogram data collected by data collection unit 110, and outputs the peak to analysis unit 117.

The time at which the peak is observed (retention time) corresponds to the type of the compound. The chromatogram is transmitted to the data analysis device. The data analysis device specifies the compound from the retention time of the peak included in the chromatogram. This identification is also referred to as “qualitative analysis”.

A height of the peak and an area of the peak in the chromatogram correspond to a concentration or a content of the compound in the sample. The data analysis device specifies the concentration and content of the compound of the sample from the height or area value of the peak included in the chromatogram. This identification is also referred to as “quantitative analysis”.

In the peak output from peak determination unit 116, analysis unit 117 obtains a position (time) of the peak top of the peak and an area value (or height) of the peak. Analysis unit 117 specifies the compound from information about the position of each peak on the chromatogram. In addition, analysis unit 117 calculates the content of each compound from the peak area value (or the height value) using a previously-prepared calibration curve. In this manner, analysis unit 117 executes qualitative analysis and quantitative analysis of each compound contained in the sample. Analysis unit 117 displays a qualitative analysis result and a quantitative analysis result on display device 62.

[Training Support Device]

Training support device 30 will be described below. As described above, in order to improve accuracy of peak detection by peak detection processing unit 111, training support device 30 optimizes estimation model 121. Furthermore, in the first embodiment, a manufacturer may optimize estimation model 121 at a manufacturing stage of analysis system 100. Furthermore, analysis system 100 may be shipped to a user, and the user may optimize estimation model 121. In this case, the user prepares training data optimizing estimation model 121, and the user himself/herself executes annotation processing. Accordingly, the user can generate estimation model 121 desired by the user.

In general, performance of machine-learned estimation model 121 is not perfect, and is operated on an assumption that some errors is generated in peak detection. As described above, in the first embodiment, the user himself/herself can train estimation model 121, so that convenience of the user can be improved.

In general, the performance of estimation model 121 greatly depends on quality of the training data. In particular, preferably various chromatograms are covered and that an accurate training label is given to the chromatogram.

In the first embodiment, two techniques exist as a technique for optimizing estimation model 121 by the user. The first technique is a technique in which the user performs correction work of the peak detected by peak detection processing unit 111. Specifically, analysis system 100 displays a chromatogram image of the chromatogram and a peak information image of peak information given to the chromatogram on display device 62. The peak information image corresponds to a “detected peak image” described later. The chromatogram image is an image illustrating the chromatogram. The peak information image is an image indicating the peak information. The peak information is information specifying the peak of the chromatogram. Analysis system 100 receives correction of the displayed peak information by the user.

The second technique is a technique in which the user performs peak designation work on the chromatogram (chromatogram in which the peak is not detected) newly collected by data collection unit 110. Specifically, analysis system 100 displays the chromatogram image on display device 62 and does not display the peak information image. Then, analysis system 100 receives input of the peak information with respect to the displayed chromatogram image. In addition, the input peak information is a label or training data that optimizes estimation model 121.

As described above, in both the first technique and the second technique, analysis system 100 receives the input of the peak information from the user as the training data. As a result of the user inputting the peak information, the parameters of estimation model 121 are updated using the input peak and chromatogram as new training data. Peak detection processing unit 111 can use updated estimation model 121. However, when the user performs the annotation that is not consistent with the past annotation (variation is generated), sometimes the accuracy of estimation model 121 decreases.

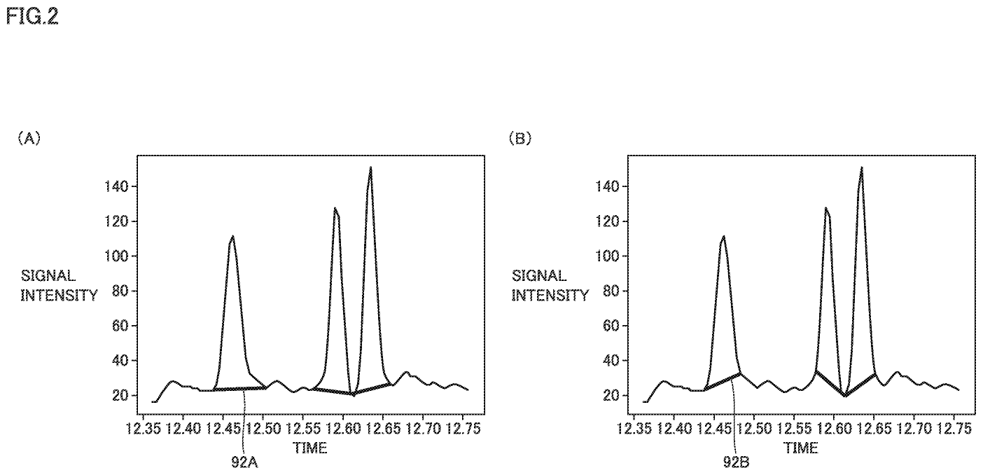

In addition, sometimes the preparation of estimation model 121 requires the annotation of a large amount of training data. FIG. 2 is a view illustrating an example in which different training data is assigned to the same chromatogram (inconsistent annotation is executed). FIG. 2(A) is a view illustrating that the peak of the chromatogram is widely designated by the user. FIG. 2(B) is a view illustrating that the peak of the chromatogram is narrowly designated by the user. In FIG. 2 and the drawings illustrating the chromatograms described later, a horizontal axis represents time, and a vertical axis represents signal intensity. Furthermore, in the first embodiment, the peak information (training data) input by the user is peak information 92A and peak information 92B.

For example, it is assumed that the user inputs peak information 92A (see FIG. 2(A)) for first-time chromatogram, and the user inputs peak information 92B (see FIG. 2(B)) for second-time chromatogram. In this case, different pieces of peak information (training data) are input to the same chromatogram, namely, the annotation varies. When the variation of the annotation is generated in this way, the quality of estimation model 121 is sometimes degraded.

Accordingly, training support device 30 of the first embodiment encourages the user to input the peak information so as to prevent variation in annotations (so as to have consistency with past peak information). Thus, training support device 30 can support training of estimation model 121 by the user.

[Hardware Configuration of Training Support Device]

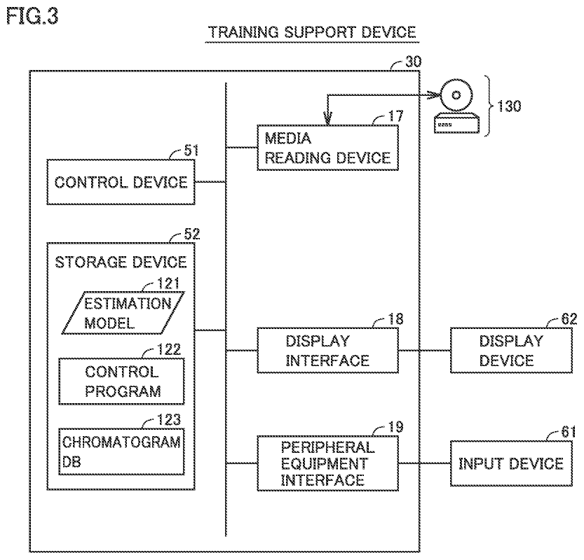

FIG. 3 is a block diagram illustrating a hardware configuration example of training support device 30 of the first embodiment. As illustrated in FIG. 3, training support device 30 includes a controller 51, a storage device 52, a media reading device 17, a display interface 18, and an input interface 26 as a main hardware element.

Controller 51 updates estimation model 121 as described later. For example, controller 51 includes a central processing unit (CPU), a field programmable gate array (FPGA), and a graphics processing unit (GPU). Controller 51 may include at least one of the CPU, the FPGA, and the GPU, or may include the CPU and the FPGA, the FPGA and the GPU, the CPU and the GPU, or all of the CPU, the FPGA, and the GPU. Controller 51 may be configured by an arithmetic circuit (processing circuitry).

Storage device 52 includes a volatile storage region (for example, working area) that temporarily stores a program code, a work memory, and the like when controller 51 executes an arbitrary program. For example, storage device 52 is constructed with a volatile memory device such as a dynamic random access memory (DRAM) or a static random access memory (SRAM). Furthermore, storage device 52 includes a nonvolatile storage region. For example, storage device 52 includes a nonvolatile memory device such as a hard disk or a solid state drive (SSD).

In the first embodiment, the example in which the volatile storage region and the nonvolatile storage region are included in the same storage device 52 has been described. However, the volatile storage region and the nonvolatile storage region may be included in different storage devices. For example, controller 51 may include the volatile storage region, and storage device 52 may include the nonvolatile storage region. Training support device 30 may include a microcomputer including controller 51 and storage device 52.

Storage device 52 stores an estimation model 121, a control program 122, and a chromatogram database (DB) 123. Estimation model 121 includes a neural network and parameters used in processing in the neural network. Estimation model 121 is configured of a convolution neural network (CNN) or the like. Control program 122 is a program executed by controller 51.

Estimation model 121 includes at least a program capable of the machine learning, and the parameter is optimized (adjusted) by performing the machine learning based on training data (training data). Training support device 30 transmits optimized estimation model 121 to data analysis device 25. Data analysis device 25 updates estimation model 121 stored in model storage 114 to transmitted estimation model 121 (optimized estimation model). As described above, peak detection processing unit 111 can improve estimation accuracy by estimating the peak using updated estimation model 121.

Medium reading device 17 receives recording medium 130 such as a removable disk, and acquires the data stored in recording medium 130. For example, the data is the control program. Furthermore, control program 122 may be stored in recording medium 130 (for example, a removable disk) and distributed as a program product. Alternatively, control program 122 may be provided as the program product that can be downloaded by an information provider through the Internet or the like. Controller 51 reads the program provided by recording medium 130, the Internet, or the like. Controller 51 stores the read program in a prescribed storage region (storage region of storage device 52). Controller 51 executes the training support processing described later by executing stored control program 122.

The recording medium 130 is not limited to a digital versatile disk read only memory (DVD-ROM), a compact disc read-only memory (CD-ROM), a flexible disk (FD), or a hard disk, but may be a medium that fixedly carries a program, such as a magnetic tape, a cassette tape, an optical disk (magnetic optical disc (MO)/mini disc (MD)/digital versatile disc (DVD)), an optical card, and a semiconductor memory such as a mask ROM, an erasable programmable read-only memory (EPROM), an electrically erasable programmable read-only memory (EEPROM), or a flash ROM. Recording medium 130 is a non-transitory medium in which control program 122 or the like can be read by the computer.

Display interface 18 is an interface connecting display device 62, and implements input and output of data between training support device 30 and display device 62. Input interface 26 is an interface connecting input device 61, and implements input and output of data between training support device 30 and input device 61.

[Functional Block of Training Support Device]

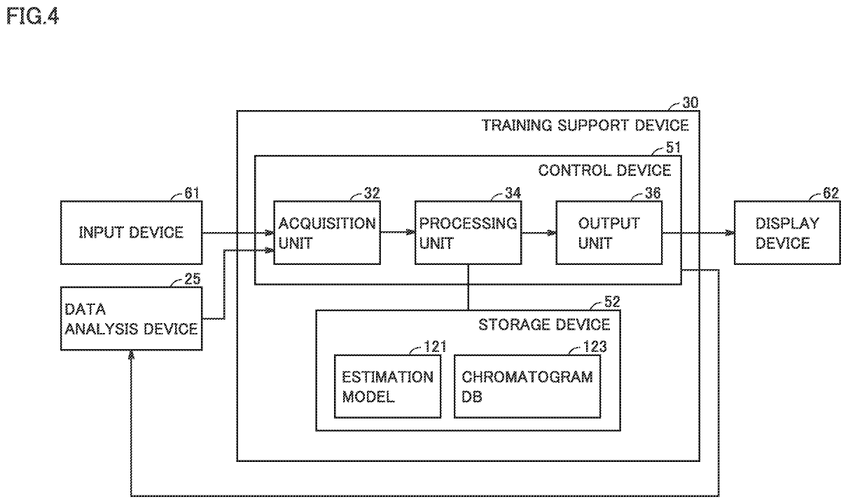

FIG. 4 is a functional block diagram illustrating training support device 30. As described above, training support device 30 includes controller 51 and storage device 52. Controller 51 further includes an acquisition unit 32, a processing unit 34, and an output unit 36.

Acquisition unit 32 acquires information input by the user through input device 61. For example, the information is the peak information described above. In addition, data collection unit 110 transmits chromatogram data to training support device 30 every time the chromatogram is collected. Acquisition unit 32 acquires the chromatogram data from data collection unit 110. The information (peak information and chromatogram data) acquired by acquisition unit 32 is output to processing unit 34.

Processing unit 34 executes processing according to a type of information output from acquisition unit 32. When the peak information is input by acquisition unit 32, the parameter of estimation model 121 is updated based on the peak information. When the chromatogram data is input by acquisition unit 32, a chromatogram DB 123 is updated. Processing unit 34 executes various other pieces of processing.

Output unit 36 outputs various signals or information. For example, output unit 36 transmits image data of an image displayed on display device 62 to display device 62. Display device 62 displays the image based on the image data.

Furthermore, every time estimation model 121 is updated, output unit 36 outputs the updated estimation model to model storage 114. Model storage 114 stores the updated estimation model.

[Chromatogram DB]

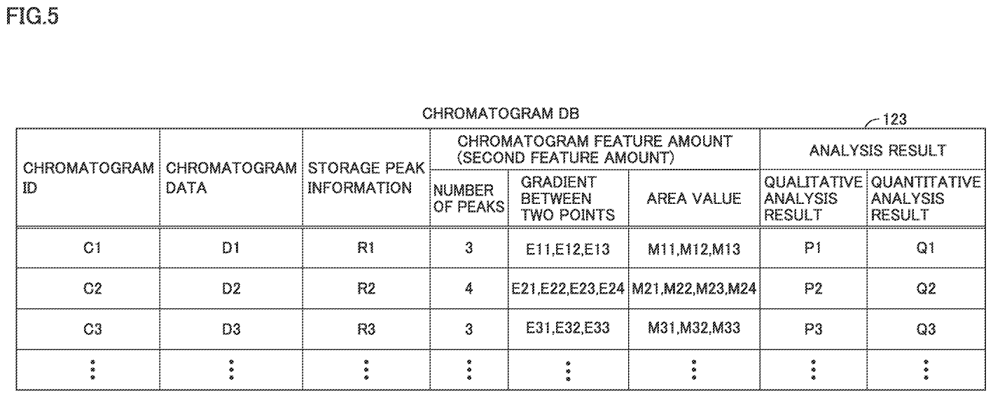

FIG. 5 is a view illustrating an example of chromatogram DB 123. As described above, chromatogram DB 123 is stored in storage device 52. In chromatogram DB 123, the chromatogram data, storage peak information, a feature amount of the chromatogram indicated by the chromatogram data, and an analysis result are associated with a chromatogram identification (ID). The chromatogram data and the storage peak information are also referred to as an “annotated signal”.

S chromatogram IDs (S is an integer of at least 1) are stored in chromatogram DB 123. Chromatogram DB 123 stores the chromatogram prepared in the past by analysis device 10 or a device equivalent to analysis device 10, the feature amount of the chromatogram, the analysis result derived from the chromatogram, and the like. In other words, at least one (or a plurality of) annotated signal is stored in chromatogram DB 123.

Chromatogram ID is information identifying the chromatogram. The chromatogram data is data indicating the chromatogram, and is digital data collected by data collection unit 110. The chromatogram data corresponds to the “storage signal waveform” of the present disclosure.

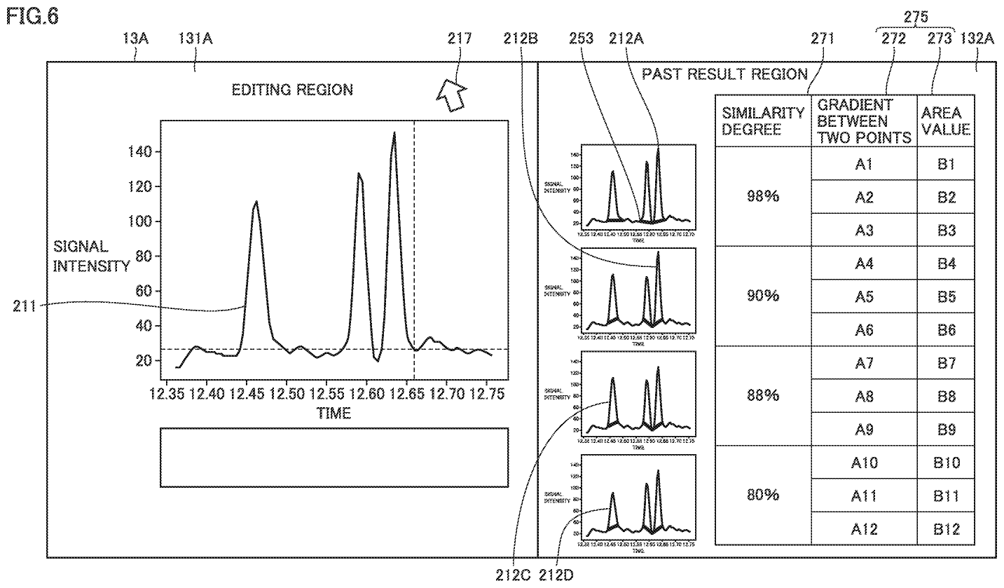

The storage peak information is data specifying a peak included in the chromatogram. For example, the peak information is indicated by a second peak information image 253 in FIG. 6 and the like described later. The storage peak information is information indicating the peak detected by peak detection processing unit 111 or peak information input by the user.

The chromatogram feature amount is the feature amount of the chromatogram indicated by the chromatogram data. In the example of FIG. 5, the chromatogram feature amount includes the number of peaks of the chromatogram, a gradient between two points, and an area value. The gradient between two points refers to a gradient of a line segment connecting a start point of the peak and an end point of the peak. The area value is an area value of a region surrounded by the line segment forming the peak of the chromatogram and the line segment by the gradient between two points. The peak indicated by the chromatogram feature amount is a peak indicated by the storage peak information.

In addition, the gradient between two points and the area value are also a feature amount (hereinafter, also referred to as a “peak feature amount”) of the peak. The peak feature amount exists for the number of peaks. For example, the chromatogram in which the chromatogram ID is C1 illustrates the number of peaks of 3. E11, E12, E13 are illustrated as gradients between two points of three peaks. M11, M12, M13 are illustrated as area values of the three peaks.

The analysis result is a result derived based on the peak detected by peak detection processing unit 111 using current estimation model 121 as the peak of the chromatogram of the chromatogram data corresponding to the analysis result. The analysis result includes at least one of a qualitative analysis result and a quantitative analysis result. The qualitative analysis result is a result indicating the compound specified by the chromatogram. The quantitative analysis result is a result indicating the compound amount. As a modification, the analysis result may include the qualitative analysis result but may not include the quantitative analysis result.

In the example of FIG. 5, chromatogram data D1, the number of peaks G1, the gradient between two points E1, area value M1, a qualitative analysis result P1, a quantitative analysis result Q1, and storage peak information R1 are associated with a chromatogram ID that is C1.

As described above, at least one storage signal waveform output by the analysis device and at least one storage peak information specifying each peak of the at least one storage signal waveform are stored in chromatogram DB 123.

[Training Support]

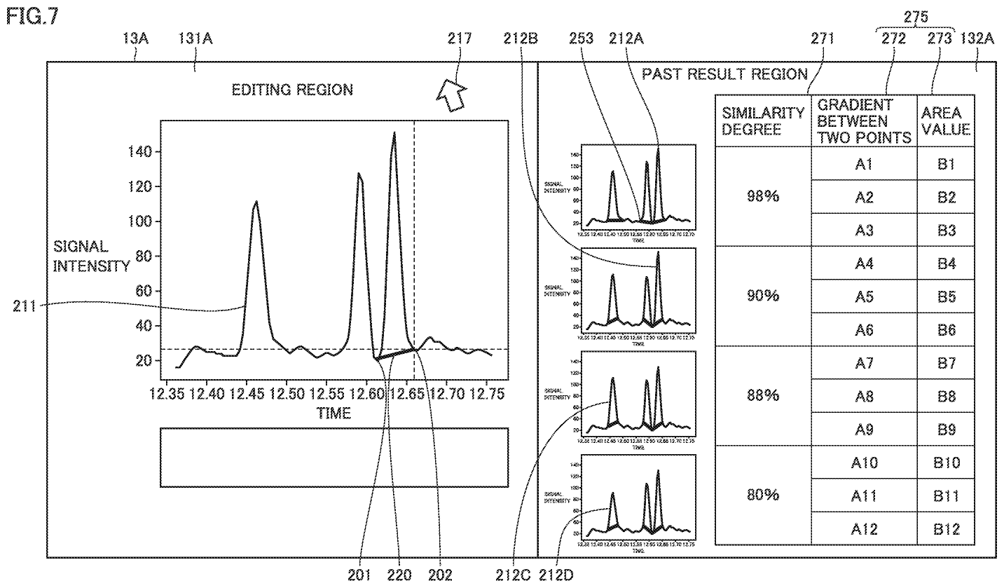

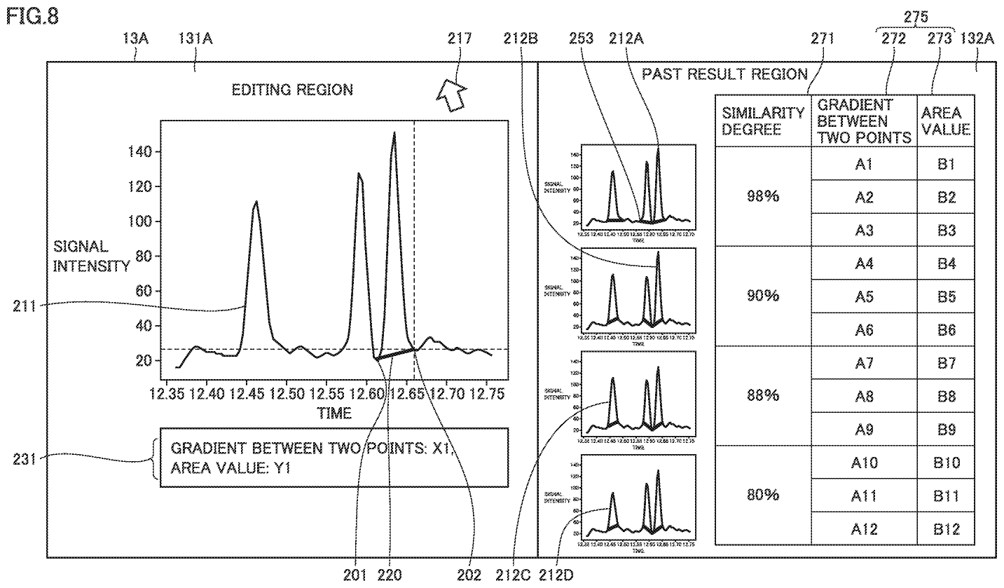

A technique of training support for the user by training support device 30 of the first embodiment will be described below. Training support device 30 executes the training support for the user by displaying various images in a display region 62A of display device 62. FIGS. 6 to 8 are views illustrating examples of the various images of the first embodiment. In the first embodiment, the image in FIG. 6 is displayed, then the image in FIG. 7 is displayed, and then the image in FIG. 8 is displayed.

When a prescribed operation is performed on input device 61 by the user, the mode of analysis system 100 is shifted to the training mode. In the training mode, the user inputs first peak information described later to update estimation model 121.

As illustrated in FIGS. 6 to 8, display region 62A includes an editing region 131A and a past result region 132A adjacent to editing region 131A. In other words, editing region 131A and past result region 132A are set to the same screen. The image (hereinafter, also referred to as a “first chromatogram image 211”) of the chromatogram (hereinafter, also referred to as a “first chromatogram”) derived by analysis device 10 is displayed in editing region 131A. The pseudo chromatogram corresponds to the “first signal waveform” of the present disclosure. First chromatogram image 211 corresponds to the “first waveform image” of the present disclosure. When acquiring the chromatogram data collected by data collection unit 110, training support device 30 displays the image of the chromatogram of the chromatogram data as first chromatogram image 211.

When acquiring the first chromatogram, training support device 30 specifies a second chromatogram same as or similar to the first chromatogram from the chromatogram DB (FIG. 5) and acquires the specified second chromatogram. Here, a specific technique example of the second chromatogram that is the same as or similar to the first chromatogram will be described.

Training support device 30 calculates first similarity degree between each of the S pieces of stored chromatogram data stored in the chromatogram DB and the first chromatogram. That is, training support device 30 calculates S first similarity degrees. The first similarity degree indicates a degree of similarity between one piece of storage chromatogram data and the first chromatogram. The first similarity degree has a larger value as one piece of storage chromatogram data is more similar to the first chromatogram. In the first embodiment, the first similarity degree is expressed by %. In addition, the first similarity degree of the second chromatogram that is the same as the first chromatogram is 100%.

The first similarity degree is calculated from the following two viewpoints. As a first aspect, training support device 30 calculates the first similarity degree based on the feature amount (hereinafter, also referred to as a “first feature amount”) of the first chromatogram and the feature amount (hereinafter, also referred to as a “second feature amount”) of the same type as the feature amount (first feature amount) of the storage chromatogram.

In the first embodiment, the first feature amount is a feature amount derived based on the peak detected by peak detection processing unit 111 using current estimation model 121 as the peak of the first chromatogram. In the first embodiment, the feature amount is the same type as the second feature amount of the storage chromatogram in FIG. 5. Specifically, the first feature amount and the second feature amount are the number of peaks, the gradient between two points, and the area value. The first feature amount and the second feature amount may be of other types as long as they are of the same type. The other type may be at least one of a peak width, a peak separation degree, a peak reading, a peak tailing, and the like.

As a second aspect, training support device 30 calculates the first similarity based on the analysis result indicated (derived) by the first chromatogram and the analysis result indicated by the storage chromatogram. Here, as illustrated in FIG. 5, the analysis result illustrated by the storage chromatogram includes the qualitative analysis result and the quantitative analysis result corresponding to the storage chromatogram. In addition, the analysis results indicated by the first chromatogram are the qualitative analysis result and the quantitative analysis result (that is, the analysis result of the same type as the analysis result indicated by the storage chromatogram) indicated by the first chromatogram.

For example, training support device 30 compares the qualitative analysis result indicated by the first chromatogram with the qualitative analysis result corresponding to the storage chromatogram, and sets the first similarity to “0” when both the qualitative analysis results are different from each other. On the other hand, when both the qualitative analysis results are the same, training support device 30 calculates the similarity degree (hereinafter, also referred to as a “first temporary similarity degree”) between both the quantitative analysis results. Furthermore, training support device 30 calculates a second temporary similarity based on the first feature amount and the second feature amount. The second temporary similarity degree is calculated using, for example, the correlation coefficient. In addition, the second temporary similarity may be calculated as the similarity degree between the shape of the first chromatogram and the shape of the storage chromatogram.

Then, training support device 30 calculates the first similarity degree based on the first temporary similarity degree and the second temporary similarity degree. As described above, training support device 30 calculates S (the number of chromatogram IDs stored in chromatogram DB) first similarity degrees by combining the similarity degree (first similarity degree) calculated from the first viewpoint and the similarity degree (first similarity degree) calculated from the second viewpoint.

As a modification, training support device 30 may calculate the first similarity degree from either the first viewpoint or the second viewpoint.

Training support device 30 specifies the first similarity degree that is greater than or equal to a first threshold from the calculated S first similarity degrees. Training support device 30 determines the storage chromatogram that is the specified first similarity degree as the second chromatogram. At this point, the first threshold is a predetermined threshold, and for example, the first threshold is 70%. That is, training support device 30 can determine the chromatogram (second chromatogram) having the similarity degree greater than or equal to 70% to the first chromatogram from the viewpoint of the first feature amount and the analysis result. Furthermore, training support device 30 acquires the peak information (second peak information) corresponding to the chromatogram ID of the second chromatogram by referring to chromatogram DB 123.

When acquiring the first chromatogram, the second chromatogram, and the second peak information, training support device 30 displays first chromatogram image 211 of the first chromatogram, a second chromatogram image 212 of the second chromatogram, and a second peak information image 253 of the second peak information as illustrated in FIG. 6. In the example of FIG. 6, second chromatogram images 212A, 212B, 212C, 212D of the four second chromatograms and each second peak information image 253 of four second chromatogram images 212 are displayed. Hereinafter, four second chromatogram images 212A, 212B, 212C, 212D are also referred to as “second chromatogram images 212”.

As described above, second chromatogram image 212 is an image of the second chromatogram having high similarity degree (greater than or equal to the first threshold) to the first chromatogram. Accordingly, the user can recognize the peak of the second chromatogram by visually recognizing second peak information image 253 of the chromatogram having the high similarity degree to the first chromatogram.

As illustrated in FIG. 6, when first chromatogram image 211 is displayed, training support device 30 receives input of the peak information specifying the peak of the first chromatogram indicated by first chromatogram image 211 from the user. The peak information corresponds to the “first peak information” of the present disclosure.

FIG. 7 illustrates the image when the first peak information is input by the user. In the example of FIG. 7, the image indicating the input first peak information is displayed as a first peak information image 220. Training support device 30 updates the parameter of estimation model 121 such that peak detection processing unit 111 detects the peak specified by the input first peak information as the peak of the first chromatogram.

As described above, in the first embodiment, the user can input the first peak information having consistency with the past second peak information (the second peak information displayed in past result region 132A). That is, for example, the input of different pieces of the peak information despite the same chromatogram (see FIG. 2) is prevented. Then, training support device 30 can update estimation model 121 based on the first peak information. Therefore, the update accuracy of estimation model 121 can be improved from the viewpoint of improving the specific accuracy of the peak of the first signal waveform.

In addition, training support device 30 calculates the first similarity degree between the first chromatogram and each of the S storage chromatograms, and acquires the storage chromatogram in which the first similarity degree is greater than or equal to the first threshold as the second chromatogram. Then, as illustrated in FIG. 6, training support device 30 displays first chromatogram image 211, second chromatogram image 212 of the acquired second chromatogram, and second peak information image 253.

Thereafter, as illustrated in FIG. 7, training support device 30 receives the input of the first peak information. Accordingly, the user can input the first peak information of the first chromatogram while visually recognizing the second chromatogram same as or similar to the first chromatogram and prepared in the past and second peak information image 253 indicating the peak of the second chromatogram. Accordingly, training support device 30 can encourage the user to input the training data (first peak information) in which the variation in the annotation is prevented. As a result, training support device 30 can prevent the variations in the annotations to improve the quality of the estimation model.

In addition, training support device 30 calculates the first similarity degree based on the first feature amount of the first chromatogram and the second feature amount of the same type as the first feature amount of the storage chromatogram. Accordingly, training support device 30 can calculate the first similarity degree by a relatively simple arithmetic operation.

Training support device 30 calculates the first similarity degree based on the analysis result indicated by the first chromatogram and the analysis result indicated by the storage chromatogram. Accordingly, training support device 30 can calculate the first similarity degree by a relatively simple arithmetic operation.

In the examples of FIGS. 6 and 7, training support device 30 displays the first similarity degree of the second chromatogram in association with second chromatogram image 212 indicating the second chromatogram. In the examples of FIGS. 6 and 7, a similarity degree image 271 indicating the first similarity degree is displayed. In the examples of FIGS. 6 and 7, for example, an image of “98%” is displayed as similarity degree image 271 in association with second chromatogram image 212A. Accordingly, the user can visually recognize the first similarity degree of the second chromatogram.

Furthermore, training support device 30 displays a second feature amount image 275 in association with second chromatogram image 212 in past result region 132A. Here, second feature amount image 275 indicates the feature amount of the peak specified by the second peak information indicated by second peak information image 253. Second feature amount image 275 includes an image 272 indicating the gradient between two points and an image 273 indicating the area value. The gradient between two points and the area value are feature quantities of each of at least one peak included in the second chromatogram. In the examples of FIGS. 6 and 7, the chromatogram of second chromatogram image 212A includes three peaks. In association with second chromatogram image 212A, A1, A2, S3 that are 2-point gradients of the three peaks are displayed, and B1, B2, B3 that are the area values of the three peaks are displayed.

In the first embodiment, the second chromatogram includes a high similarity chromatogram and a low similarity chromatogram having the first similarity degree lower than that of the high similarity chromatogram. For example, in the example of FIG. 7, second chromatogram image 212A of the chromatogram having the first similarity degree of 98% is displayed as an example of the high similarity chromatogram. In addition, a second chromatogram image 212D of a chromatogram having the first similarity degree of 80% is displayed as an example of the low similarity chromatogram. Furthermore, in past result region 132A, second chromatogram image 212A indicating the highly similar chromatogram is displayed in preference to a chromatogram image 212B indicating the low similar chromatogram. In this manner, training support device 30 displays second chromatogram image 212 and second peak information image 253 with priority according to the first similarity degree. In the examples of FIGS. 6 and 7, the highly similar chromatogram is displayed above the low similar chromatogram.

Accordingly, the user can visually recognize the second chromatogram having the high similarity degree to the first chromatogram in preference to the second chromatogram having the low similarity degree. Therefore, training support device 30 can easily visually recognize the second peak information of the second chromatogram having the high similarity degree to the first chromatogram.

In the example of FIG. 7, second peak information image 253 is a linear image (hereinafter, also referred to as a “line image”). The region surrounded by second chromatogram image 212 and second peak information image 253 is a region indicating the peak of the second chromatogram.

In addition, training support device 30 receives the input (designation) of a first point 201 and a second point 202 by the user while first chromatogram image 211, second chromatogram image 212, and second peak information image 253 are displayed. In the first embodiment, a cursor 217 of input device 61 (mouse) is displayed. The user can specify first point 201 by positioning cursor 217 at a desired position and clicking the mouse. In addition, the user can designate second point 202 by positioning cursor 217 at another desired position and clicking the mouse. When first point 201 and second point 202 are designated, training support device 30 displays the line image connecting first point 201 and second point 202 as first peak information image 220. Then, training support device 30 recognizes the region surrounded by the line connecting first point 201 and second point 202 and the line included in first chromatogram image 211 as the peak region (training data) specified by the first peak information of first peak information image 220. According to such the configuration, the first peak information can be input by designating first point 201 and second point 202 of first chromatogram image 211. Accordingly, the user can intuitively input the first peak information, so that the convenience of the user can be improved. The line image connecting first point 201 to second point 202 in FIG. 7 is also referred to as “baseline of peak.”

FIG. 8 is a view illustrating a screen after the first peak information is input by the user. As illustrated in FIG. 8, when the first peak information is input, training support device 30 calculates the first feature amount and displays a first feature amount image 231 of the first feature amount. Here, first feature amount image 231 indicates the feature amount of the peak specified by the first peak information indicated by first peak information image 220. In the example of FIG. 8, first feature amount image 231 is an image illustrating the gradient between two points of the peak and the area value of the peak. In the example of FIG. 8, “X1” is displayed as the value of the gradient between two points, and “Y1” is displayed as the area value.

As described above, as illustrated in FIGS. 6 to 8, training support device 30 displays second feature amount image 275 in past result region 132A. In this manner, training support device 30 displays first feature amount image 231 and second feature amount image 275. Accordingly, after inputting the first peak information, the user can compare the peak indicated by the first peak information with the past peak from the viewpoint of the feature amount (In the first embodiment, the gradient between two points and the area value).

In addition, first feature amount image 231 is displayed by the number of peaks specified by the first peak information input by the user. For example, when the number of peaks specified by the first peak information input by the user is “3”, first feature amount images 231 of the three peaks are displayed.

[Flowchart]

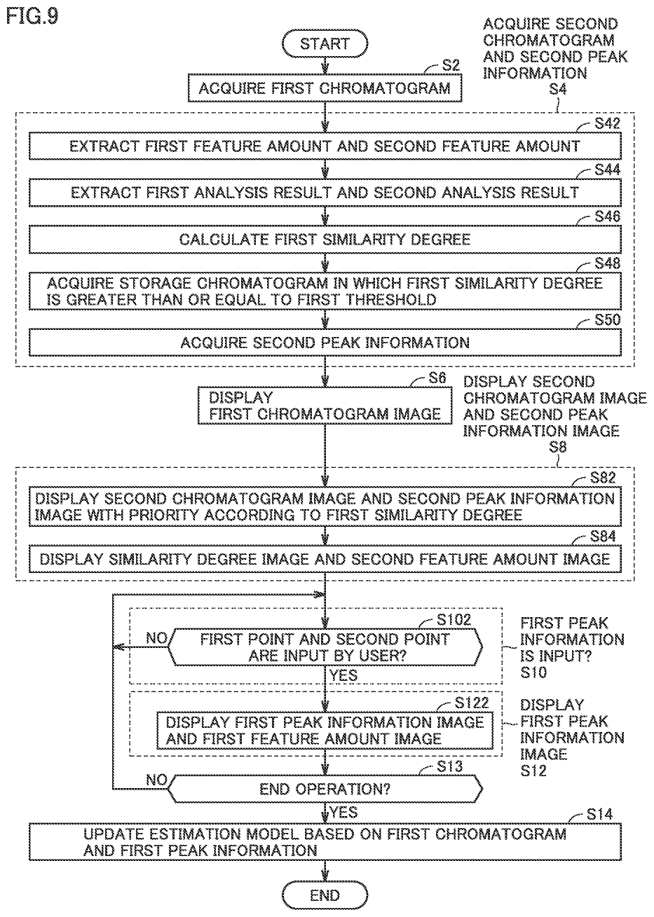

FIG. 9 is a flowchart illustrating the processing of training support device 30. In step S2, training support device 30 acquires the first chromatogram. Subsequently, in step S4, training support device 30 acquires the second chromatogram and the second peak information. Step S4 includes step S42, step S44 executed after step S42, step S46 executed after step S44, step S48 executed after step S46, and step S50 executed after step S48.

In step S42, training support device 30 extracts the first feature amount of the first chromatogram and the second feature amount of the storage chromatogram. As described above, the first feature amount and the second feature amount are the number of peaks, the gradient between two points, and the area value.

In step S44, training support device 30 extracts the first analysis result indicated by the first chromatogram and the second analysis result indicated by the storage chromatogram. The first analysis result and the second analysis result are the qualitative analysis result and the quantitative analysis result.

In step S46, training support device 30 calculates the first similarity degree between the first chromatogram and the storage chromatogram. Training support device 30 calculates the first similarity degree based on the first feature amount, the second feature amount, the first analysis result, and the second analysis result.

In step S48, training support device 30 refers to chromatogram DB 123 to acquire the storage chromatogram having the first similarity degree equal to or greater than the first threshold as the second chromatogram.

In step S50, training support device 30 refers to chromatogram DB 123 to acquire the storage peak information corresponding to the second chromatogram as the second peak information.

When the processing in step S4 is ended, in step S6, training support device 30 displays first chromatogram image 211 of the first chromatogram acquired in step S2.

Subsequently, in step S8, training support device 30 displays second chromatogram image 212 and second peak information image 253. Step S8 includes step S82 and step S84 executed after step S82.

In step S82, training support device 30 displays second chromatogram image 212 and second peak information image 253 with the priority according to the first similarity degree. In step S84, similarity degree image 271 and second feature amount image 275 are displayed.

In this way, the image in FIG. 6 is displayed by executing the pieces of processing of steps S2 to S8.

Subsequently, in step S10, training support device 30 determines whether the first peak information is input by the user. Step S10 includes the processing of step S102. In step S102, training support device 30 determines whether first point 201 and second point 202 are input by the user. Training support device 30 repeats the processing of step S102 until first point 201 and second point 202 are input. When the affirmative determination is made in step S102, the processing proceeds to step S12.

In step S12, training support device 30 displays the first peak information image of the first peak information determined to be input in step S10. Step S12 includes step S122. In step S122, training support device 30 displays first peak information image 220 and first feature amount image 231. In step S122, training support device displays first peak information image 220 to display the image in FIG. 7. In step S122, training support device 30 displays first feature amount image 231 to display the image in FIG. 8.

Subsequently, in step S13, training support device 30 determines whether an end operation is executed by the user. The end operation is an operation performed by the user on input device 61. For example, the end operation is a user operation on an end button (not illustrated) displayed on the screens in FIGS. 6 to 8.

The user can input at least one piece of first peak information to first chromatogram image 211. When the input of the first peak information ends, the user executes the end operation. When the negative determination is made in step S13, the processing returns to step S102. On the other hand, when the affirmative determination is made in step S13, the processing proceeds to step S14.

In step S14, training support device 30 trains the estimation model 121 on the basis of the first chromatogram acquired in step S2 and the first peak information determined to be input in step S10. Furthermore, estimation model 121 may be trained in a plurality of sets using the chromatogram and the peak information as a set.

As illustrated in FIG. 9, training support device 30 receives the input of the first peak information by the user after steps S6 and S8. As described above, step S6 is processing for displaying first chromatogram image 211 on display device 62. Step S8 is processing for displaying second chromatogram image 212 and second peak information image 253 on display device 62.

With the configuration in FIG. 9, the user can input the first peak information about the first chromatogram while visually recognizing the second chromatogram similar to the first chromatogram and prepared in the past and the second peak information indicating the peak of the second chromatogram. Accordingly, the convenience of the user can be improved with respect to the input of the first peak information.

### Second Embodiment

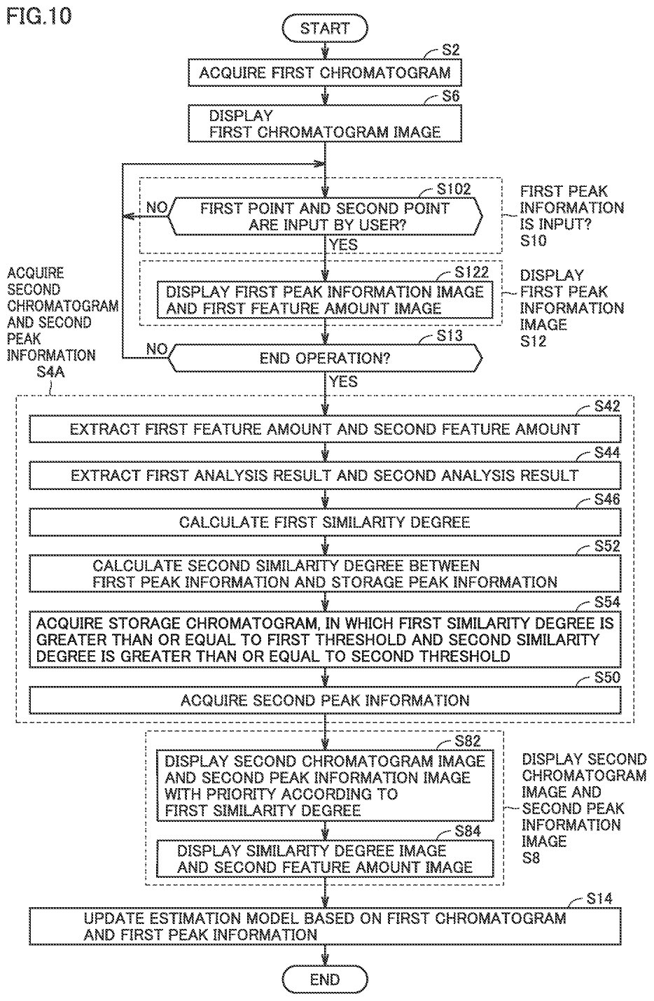

FIG. 10 is a flowchart illustrating processing of training support device 30 according to a second embodiment. In FIG. 10, when the processing of step S2 ends, training support device 30 executes the processing of step S6. Subsequently, training support device 30 executes the processing of step S10. At this point, the user inputs the first peak information while first chromatogram image 211 is displayed but second chromatogram image 212 and second peak information image 253 are not displayed. When the processing of step S10 is executed, the pieces of processing of steps S12 and S13 is executed. The affirmative determination is made in step S13. The processing proceeds to step S4A. Step S4A is different from step S4 in that step S48 is replaced with step S52 and step S54.

In step S52, training support device 30 calculates S similarity degrees (hereinafter, also referred to as the “second similarity degree”) between the first peak information input in step S10 and the S pieces of storage peak information R (see FIG. 5) stored in chromatogram DB 123. The second similarity degree indicates the degree of similarity between one piece of storage peak information and the first peak information. The second similarity degree has a larger value as one piece of storage peak information is more similar to the first peak information. For example, training support device 30 calculates the parameter (for example, the correlation coefficient) regarding each of the S pieces of storage peak information and the first peak information as the second similarity.

Subsequently, in step S54, training support device 30 acquires the storage chromatogram having the peak specified by the storage peak information, in which the first similarity degree is greater than or equal to the first threshold and the second similarity degree is greater than or equal to the second threshold, as the second chromatogram. At this point, the second threshold is a predetermined threshold. That is, the second chromatogram in which the first peak information and the chromatogram are similar to each other is acquired in step S54. Subsequently, the second peak information corresponding to the second chromatogram acquired in step S54 is acquired in step S50.

In the example of FIG. 10, training support device 30 executes the processing of step 4A after step S6 and step S10. Step S6 is processing for displaying first chromatogram image 211 on display device 62. Step S10 is processing for receiving the input of the first peak information by the user. Step 4A is processing for acquiring the second chromatogram and the second peak information from chromatogram DB 123. Step S4A includes step S46, step S52, and step S54.

Step S52 is processing for calculating the first similarity, and step S54 is processing for calculating the second similarity degree. Step S56 is processing for acquiring the storage chromatogram having the peak specified by the storage peak information, in which the first similarity degree is greater than or equal to the first threshold and the second similarity degree is greater than or equal to the second threshold, as the second chromatogram.

According to the second embodiment, training support device 30 can display the storage chromatogram having the peak specified by the storage peak information, in which the first similarity degree is greater than or equal to the first threshold and the second similarity degree is greater than or equal to the second threshold, as the second chromatogram. Consequently, the user can check such the second chromatogram.

### Third Embodiment

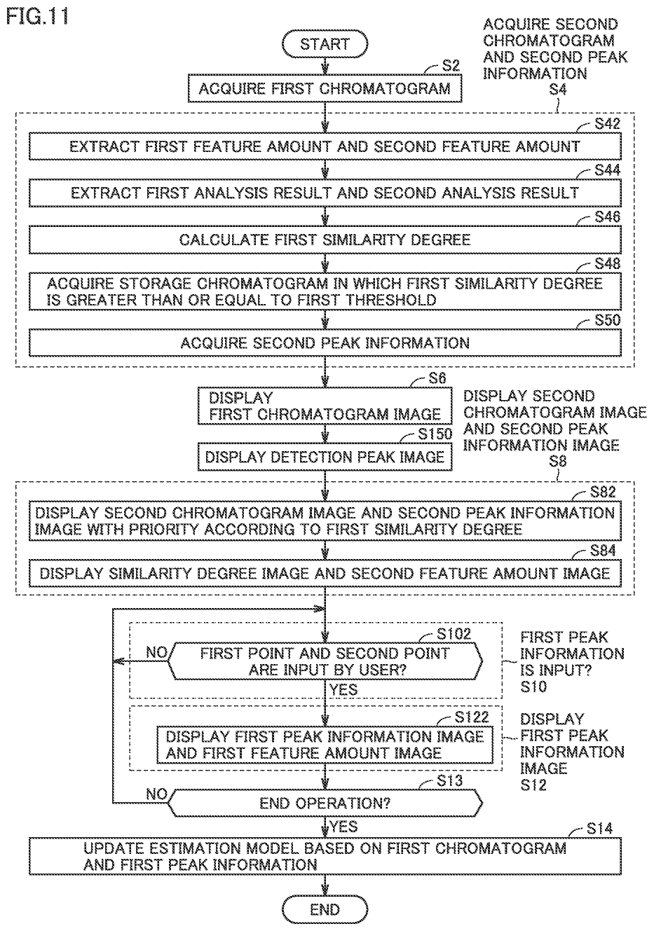

FIG. 11 is a flowchart illustrating processing of training support device 30 according to a third embodiment. In FIG. 11, after the processing of step S6 in FIG. 9, the processing of step S150 is executed. The processing of step S150 is processing for displaying the detected peak image. The detected peak image is peak information (hereinafter, also referred to as “detected peak information”) specifying the peak of the first chromatogram (the first chromatogram acquired in step S2) detected using current estimation model 121. That is, temporary peak information of the first chromatogram acquired in step S2 is displayed as the detected peak image. As described above, the first chromatogram image and the detected peak image (temporary peak image of the first chromatogram) are displayed by executing the pieces of processing of steps S6 and S150. Thereafter, the pieces of processing of steps S8 and S10 are executed.

According to the third embodiment, the user can input the first peak information while referring to the detected peak information image. Furthermore, the user can input the first peak information with reference to the detected peak information image and the second peak information image. Accordingly, the convenience of the user can be improved.

When the user determines that the first peak information image remains the detected peak image in step S102 (step S10), the user executes a predetermined operation (for example, an operation of pressing an OB button (not illustrated)), so that the affirmative determination is made in step S102 and the processing proceeds to next step S122. Furthermore, in step S102 (step S10), when the user desires to correct the detected peak image, the first peak information is newly input (first point 201 and second point 202 are designated), so that the affirmative determination is made in step S102 and the processing proceeds to next step S122.

[Modifications]

(1) In the processing of FIG. 11, training support device 30 may execute the processing in the order of step S2, step S6, step S150, step S4A (see FIG. 10), step S8, step S10, and step S12. In step S52 of step S4A, S second similarity degrees between the detected peak information and the S storage chromatograms are calculated. Accordingly, in step S54, training support device 30 acquires the chromatogram in which the first similarity degree is greater than or equal to the first threshold and the storage chromatogram in which the peak is specified by the storage peak information, in which the second similarity degree is greater than or equal to the second threshold, as the second chromatogram. That is, the first chromatogram to which the detected peak information is added and the second chromatogram image having the same or similar chromatogram and peak information are displayed. Training support device can improve the user convenience by displaying such the second chromatogram image.

(2) In the above-described embodiment, the configuration in which the user inputs the first peak information by designating first point 201 and second point 202 has been described. However, the technique of inputting the first peak information may be another technique. For example, a coordinates specifying the peak desired by the user may be input to displayed first chromatogram image 211.

(3) In the example of FIG. 7, the configuration in which the user inputs “baseline of peak (first peak information image 220)” by designating first point 201 and second point 202 has been described. In some cases, however, training support device 30 may not be able to specify a peak based on its baseline.

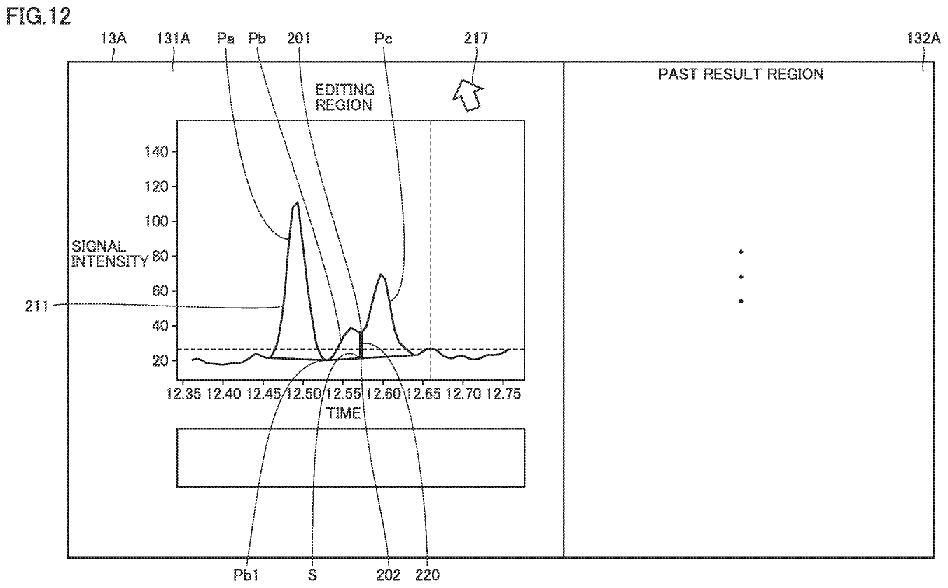

FIG. 12 illustrates an example of first chromatogram image 211 for which training support device 30 cannot specify a peak based on its baseline. On first chromatogram image 211 of FIG. 12, a peak Pa, a peak Pb, and a peak Pc are shown. In the example of FIG. 12, peak Pb and peak Pc are contiguous to each other, and a start point Pb1 of peak Pb is indicated while the end point of peak Pb is not indicated (see S in FIG. 12). In some cases, a peak having its start point and end point that both are not indicated may also be displayed (not shown). Such a peak where at least one of its start point and its end point is not indicated may be specified by a perpendicular line.

The perpendicular line is a line that is perpendicular or substantially perpendicular to the horizontal axis (time axis) of first chromatogram image 211. In the example of FIG. 12, first point 201 and second point 202 are designated by a user, and accordingly the perpendicular line is displayed as first peak information image 220. Thus, first peak information image 220 may include at least one of the baseline shown in FIG. 7 and the perpendicular line shown in FIG. 12.

In the example of FIG. 12, while details of past result region 132A are not shown, similarity degree image 271, second feature amount image 275, and second peak information image 253 such as perpendicular line, for example, are displayed.

[Aspects]

It is understood by those skilled in the art that the plurality of embodiments described above are specific examples of the following aspects.

(Clause 1) A training support method according to one aspect is a method for causing a computer to execute processing for supporting a training operation of an estimation model used to detect a peak of a signal waveform acquired by an analysis device. The training support method includes acquiring a first signal waveform output by an analysis device. The training support method includes displaying the first signal waveform on a display device. The training support method includes acquiring a second signal waveform having a high similarity degree with the first signal waveform and second peak information specifying one or more peaks of the second signal waveform from a storage device that stores a plurality of annotated signals. The training support method includes displaying, on the display device, the second signal waveform and a second peak information image indicating second peak information. The training support method includes receiving input, by a user, of first peak information specifying one or more peaks of the first signal waveform. The training support method includes training an estimation model based on the first signal waveform and the first peak information.

According to such the configuration, the user can input the first peak information having consistency with the past second peak information, and can update the estimation model based on the first peak information. Consequently, the user is encouraged to input the training data in which the variation in the annotation is prevented. As a result, the quality of the estimation model can be improved while preventing the variation of the annotation.

(Clause 2) In the training support method described in clause 1, the acquiring the second signal waveform and the second peak information from the storage device includes: calculating a first similarity degree between the first signal waveform and each of a plurality of storage signal waveforms included in the plurality of annotated signals; and acquiring a storage signal waveform having the first similarity degree greater than or equal to a first threshold as the second signal waveform. The receiving input, by a user, of first peak information includes: receiving input of first peak information after the displaying the first signal waveform on the display device and the displaying the second signal waveform and the second peak information image on the display device.

According to such the configuration, the user can input the first peak information about the first chromatogram while visually recognizing the second signal waveform similar to the first signal waveform and prepared in the past and the second peak information indicating the peak of the second signal waveform. Accordingly, the convenience of the user can be improved with respect to the input of the first peak information.

(Clause 3) In the training support method described in claim 2, the acquiring a second signal waveform and the second peak information from the storage device includes: acquiring the second signal waveform and the second peak information after the displaying the first signal waveform on the display device and the receiving the input of the first peak information by the user The acquiring the second signal waveform and the second peak information from the storage device includes: calculating a first similarity degree between the first signal waveform and each of a plurality of storage signal waveforms included in the plurality of annotated signals; calculating a second similarity degree between the first peak information and each of a plurality of pieces of storage peak information included in the plurality of annotated signals; and acquiring a storage signal waveform as the second signal waveform, the storage signal waveform having one or more peaks specified by storage peak information, in which the first similarity degree is greater than or equal to a first threshold and the second similarity degree is greater than or equal to a second threshold.

According to such the configuration, the storage signal waveform having the peak specified by the storage peak information, in which the first similarity degree is greater than or equal to the first threshold and the second similarity degree is greater than or equal to the second threshold, can be displayed as the second signal waveform. Consequently, the user can check such the second signal waveform.

(Clause 4) In the training support method described in clause 2 or 3, the second signal waveform includes a highly-similar signal waveform and a low-similar signal waveform having the first similarity degree lower than that of the highly-similar signal waveform. The displaying the second signal waveform and the second peak information image on the display device includes displaying a waveform image indicating the highly-similar signal waveform in preference to a waveform image indicating the low-similar signal waveform.

According to such the configuration, the user can visually recognize the second signal waveform having the high similarity degree to the first signal waveform in preference to the second signal waveform having the low similarity.

(Clause 5) In the training support method described in any one of clauses 2 to 4, the displaying the second signal waveform and the second peak information image on the display device includes displaying the first similarity degree of the second signal waveform in association with a second signal waveform image indicating the second signal waveform.

According to such the configuration, the user can visually recognize the first similarity degree of the second signal waveform.

(Clause 6) In the training support method described in any one of terms 2 to 5, the calculating the first similarity degree includes calculating the first similarity degree based on a first feature amount of the first signal waveform and a second feature amount of an identical type of the first feature amount of the storage signal waveform.

According to such the configuration, the first similarity degree can be calculated by a relatively simple arithmetic operation.

(Clause 7) In the training support method described in any one of clauses 2 to 6, the calculating the first similarity degree includes calculating the first similarity degree based on an analysis result indicated by the first signal waveform and an analysis result indicated by the storage signal waveform.

According to such the configuration, the first similarity degree can be calculated by a relatively simple arithmetic operation.

(Clause 8) In the training support method described in any one of the first to seventh clauses, the training support method further includes displaying a first peak information image indicating the first peak information on the display device.

According to such the configuration, the display device can recognize the first peak information input by the user.

(Clause 9) In the training support method described in clause 8, the displaying the first peak information image on the display device includes displaying a first feature amount image indicating a feature amount of one or more peaks specified by first peak information indicated by the first peak information image In addition, the displaying the second signal waveform and the second peak information image on the display device includes displaying a second feature amount image indicating a feature amount of one or more peaks specified by second peak information indicated by the second peak information image.

According to such the configuration, after the user inputs the first peak information, the user can recognize the feature amount of the peak specified by the peak of the first peak information and the feature amount of the peak specified by the second peak information. Accordingly, the user can check whether the input first peak information is appropriate.

(Clause 10) In the training support method described in any one of clauses 1 to 9, the training support method further includes displaying a detected peak information image indicating detected peak information specifying one or more peaks of the first signal waveform detected using the estimation model. The receiving input, by a user, of first peak information includes: receiving input of first peak information after the detected peak information image and the first signal waveform are displayed.

According to such the configuration, the user can input the first peak information while referring to the detected peak information.

(Clause 11) In the training support method described in any one of clauses 1 to 10, the training support method further includes receiving input of a first point and a second point by the user while the first signal waveform is displayed on the display device. The second peak information image is a line image. A region surrounded by the second signal waveform and the line image is a region indicating the one or more peaks of the second signal waveform. A peak region specified by the first peak information is a region surrounded by a line connecting the first point and the second point and a line included in the first signal waveform.

According to such the configuration, the first peak information can be input by designating the first point and the second point of the first signal waveform. Accordingly, the user can relatively easily input the first peak information, so that the convenience of the user can be improved.

(Clause 12) A training support program according to one aspect is a program for causing a computer to execute processing for supporting a training operation of an estimation model used to detect a peak of a signal waveform acquired by an analysis device. The training support program causes the computer to acquire a first signal waveform output by an analysis device. The training support program causes the computer to display the first signal waveform on a display device. The training support program causes the computer to acquire a second signal waveform having a high similarity degree to the first signal waveform and second peak information specifying one or more peaks of the second signal waveform from a storage device that stores a plurality of annotated signals. The training support program causes the computer to display, on the display device, the second signal waveform and a second peak information image indicating the second peak information. The training support program causes the computer to receive input, by a user, of first peak information specifying one or more peaks of a first signal waveform. The training support program causes the computer to train the estimation model based on the first signal waveform and the first peak information.

According to such the configuration, the user can input the first peak information having consistency with the past second peak information, and can update the estimation model based on the first peak information. Consequently, the user is encouraged to input the training data in which the variation in the annotation is prevented. As a result, the quality of the estimation model can be improved while preventing the variation of the annotation.

For the above-described embodiments and modifications, it is planned from the beginning of the application to appropriately combine the configurations described in the embodiments within a range in which no inconvenience or contradiction occurs including combinations not mentioned in the specification.

Although the embodiments of the present invention has been described, it should be considered that the disclosed embodiment is an example in all respects and not restrictive. The scope of the present invention is indicated by the claims, and it is intended that all modifications within the meaning and scope of the claims are included in the present invention.

What is claimed is:

1. A training support method for causing a computer to execute processing for assisting a training operation of an estimation model used to detect a peak of a signal waveform acquired by an analysis device, the training support method comprising:
acquiring a first signal waveform output by an analysis device;
displaying the first signal waveform on a display device;
acquiring a second signal waveform having a high similarity degree to the first signal waveform and second peak information specifying one or more peaks of the second signal waveform from a storage device that stores a plurality of annotated signals;
displaying, on the display device, the second signal waveform and a second peak information image indicating the second peak information;
receiving input, by a user, of first peak information specifying one or more peaks of the first signal waveform; and
training the estimation model based on the first signal waveform and the first peak information.

2. The training support method according to claim 1, wherein
the acquiring the second signal waveform and the second peak information from the storage device includes:
calculating a first similarity degree between the first signal waveform and each of a plurality of storage signal waveforms included in the plurality of annotated signals; and
acquiring a storage signal waveform having the first similarity degree greater than or equal to a first threshold as the second signal waveform, and
the receiving input, by a user, of first peak information includes:
receiving input of first peak information after the displaying the first signal waveform on the display device and the displaying the second signal waveform and the second peak information image on the display device.

3. The training support method according to claim 1, wherein
the acquiring a second signal waveform and the second peak information from the storage device includes:
acquiring the second signal waveform and the second peak information after the displaying the first signal waveform on the display device and the receiving the input of the first peak information by the user, and
the acquiring the second signal waveform and the second peak information from the storage device includes:
calculating a first similarity degree between the first signal waveform and each of a plurality of storage signal waveforms included in the plurality of annotated signals;
calculating a second similarity degree between the first peak information and each of a plurality of pieces of storage peak information included in the plurality of annotated signals; and
acquiring a storage signal waveform as the second signal waveform, the storage signal waveform having one or more peaks specified by storage peak information, in which the first similarity degree is greater than or equal to a first threshold and the second similarity degree is greater than or equal to a second threshold,

4. The training support method according to claim 2, wherein
the second signal waveform includes a highly-similar signal waveform and a low-similar signal waveform having the first similarity degree lower than that of the highly-similar signal waveform, and
the displaying the second signal waveform and the second peak information image on the display device includes displaying a waveform image indicating the highly-similar signal waveform in preference to a waveform image indicating the low-similar signal waveform.

5. The training support method according to claim 2, wherein the displaying the second signal waveform and the second peak information image on the display device includes displaying the first similarity degree of the second signal waveform in association with a second signal waveform image indicating the second signal waveform.

6. The training support method according to claim 2, wherein the calculating the first similarity degree includes calculating the first similarity degree based on a first feature amount of the first signal waveform and a second feature amount of an identical type of the first feature amount of the storage signal waveform.

7. The training support method according to claim 2, wherein the calculating the first similarity degree includes calculating the first similarity degree based on an analysis result indicated by the first signal waveform and an analysis result indicated by the storage signal waveform.

8. The training support method according to claim 1, further comprising displaying a first peak information image indicating the first peak information on the display device.

9. The training support method according to claim 8, wherein
the displaying the first peak information image on the display device includes displaying a first feature amount image indicating a feature amount of one or more peaks specified by first peak information indicated by the first peak information image, and
the displaying the second signal waveform and the second peak information image on the display device includes displaying a second feature amount image indicating a feature amount of one or more peaks specified by second peak information indicated by the second peak information image.

10. The training support method according to claim 1, further comprising displaying a detected peak information image indicating detected peak information specifying one or more peaks of the first signal waveform detected using the estimation model,
wherein the receiving input, by a user, of first peak information includes:
receiving input of first peak information after the detected peak information image and the first signal waveform are displayed.

11. The training support method according to claim 1, further comprising receiving input of a first point and a second point by the user while the first signal waveform is displayed on the display device,
wherein the second peak information image is a line image,
a region surrounded by the second signal waveform and the line image is a region indicating the one or more peaks of the second signal waveform, and
a peak region specified by the first peak information is a region surrounded by a line connecting the first point and the second point and a line included in the first signal waveform.
